(19) United States
(12) Patent Application Publication
(10) Pub. No.: US 2018/0127841 A1
(43) Pub. Date: May 10, 2018

(54) Peptide Pet Food Material Having Anti-Stress Action and Palatability-Increasing Effect

(71) Applicant: School Juridical Person Kitasato Institute, Tokyo (JP)

(72) Inventor: Keizo Arihara, Kanagawa (JP)

(21) Appl. No.: 15/680,591

(22) Filed: Aug. 18, 2017

Related U.S. Application Data
(63) Continuation of application No. 12/219,325, filed on Jul. 18, 2008, now abandoned.

(30) Foreign Application Priority Data
Jul. 19, 2007 (JP) 2007-188378

(51) Int. Cl. A23K 10/20; A23K 10/14; A23K 20/147; A23K 40/25; A23K 40/20; A23K 50/42

(52) U.S. Cl. CPC C12Y 304/22002; A23K 10/20; A23K 10/14; A23K 50/42; A23K 40/25; A23K 40/20; A23K 20/147

(57) ABSTRACT

The present invention provides a safe pet food material having an anti-stress action and effect of increasing palatability. Livestock meat or fish meat is treated with a protease such as papain to obtain a pet food material with excellent thermal stability having peptides consisting of 2-10 amino acid residues as a principal active ingredient. A pet food exhibiting an anti-stress action and having high palatability is obtained by blending this material.

### CROSS REFERENCE TO RELATED APPLICATIONS

The present application is a continuation of U.S. patent application Ser. No. 12/219,325, filed Jul. 18, 2008, which claims priority to Japanese Patent Application No. 2007-188378, filed Jul. 19, 2007, the disclosures of which are incorporated by reference herein in their entirety.

### BACKGROUND OF THE INVENTION

This invention relates to a pet food material which has an anti-stress action, a palatability-increasing effect, and excellent thermal stability, a pet food which contains the material, a supplement for pets, and a method of decreasing stress in pets.

In recent years, the environments in which pets such as dogs and cats are raised are markedly changing as the significance of pets in society increases. At the same time that pets are being carefully treated like members of the family, they are being exposed to various new stresses. For example, being raised indoors often causes an animal of a type which was originally raised outdoors to undergo extremely great stresses. In particular, confined indoor spaces such as condominiums and apartments in the city are for many animals harsh environments in which to live. Outdoor environments which animals contact during walks or the like are filled with many stress factors such as the noise and air pollution of the city. Furthermore, due to the increase of single-person households, the time for which pets contact their owners is limited, and there is a tendency for the opportunity for walks and the like to decrease. The imposition of such stresses can easily lead to a situation in which health is impaired due to loss of appetite or self-destructive behavior, which leads to various illnesses. Due to accumulated stress, there are many dogs and cats which exhibit behavior which is troublesome to their owners or person in their vicinity such as needless howling, violent behavior, and inappropriate defecation. There are cases in which such behavior causes health problems such as stress-related illnesses of the owner or serious problems with neighbors.

One method of dealing with stress-related problems of pets is to feed them pet food which has a stress-reducing effect. For example, it has been disclosed that a trypsin-degradation product of casein (cow's milk protein) has the effect of reducing stress in pets, and the material has been proposed as a stress-reducing material for pets (Patent Document 1). However, this degradation product is very bitter and astringent, and when it is used as a raw material for pet food, it has the drawback that it is necessary to take steps such as adding various extracts and flavors in order to improve its palatability. It is also known to add a degradation product of soybean peptide to pet food as a degradation product of protein, but this material has problems with respect to palatability such as bitterness (Patent Document 2).

Anti-stress food materials developed for addition to food for humans such as GABA (γ-amino butyric acid), polyphenol, and catechin have come to be used in pet foods. However, many such materials are being used without adequate data concerning their anti-stress action in pets such as dogs and cats, and they often have problems with respect to palatability when used in pet foods. Dogs and cats are descended from carnivores, and they greatly differ from omnivores such as mice, rats, and humans with respect to nutritional physiological characteristics and food preferences. Cats, in particular, are even now clearly carnivores, and they have a unique digestive absorption mechanism suited for absorption of large amounts of proteins. In addition, the stress factors to which dogs and cats are exposed and their stress responses are different in character from those of other animals (such as humans). Therefore, anti-stress materials used in pet food need to be developed taking into consideration the nutritional physiological characteristics and preferences of dogs and cats. In particular, when a material having low palatability is blended as a pet food material, the amount eaten by dogs or cats becomes extremely small, and not only can the material not be expected to exhibit a health-maintaining function, but its market value as pet food is markedly impaired.

The present inventors reported that physiologically active peptides are formed by protease treatment (decomposition) of livestock meat or livestock meat protein (non-Patent Documents 1 and 2, Patent Documents 3 and 4). Such peptides include blood pressure-lowering peptides, anti-oxidizing peptides, and anti-fatigue peptides, for example. As an extremely large variety of proteins are present in livestock meat or fish meat, it is expected that various peptides can be formed by protease treatment. However, there are no reports of peptides having an anti-stress action.

The present inventors showed that oral administration of a lactic acid bacteria fermentate or a protease-treated substance of a pork homogenate to rats is effective at preventing stress-induced stomach ulcers and suggested the possibility of its use as a functional food material for humans (Patent Document 5). However, considering that up to now there have been absolutely no studies of anti-stress action performed on pets and the unique nutritional physiological characteristics of dogs and cats which are descended from carnivores, the effect of such a material is extremely difficult to predict only from data obtained using omnivorous laboratory animals such as mice or rats. Moreover, it is necessary to take into consideration the preferences of dogs and cats in the development of materials used in pet food for dogs and cats. In addition, no reports have been found studying degradation products of fish meat protein.

The high-temperature heat treatment which is carried out during the manufacture of almost all pet foods (at around 110-140° C.) makes it necessary that materials used in pet food have a high degree of thermal stability. This is yet another hurdle not experienced with respect to food materials for humans. According to studies by the present inventors, at present, collagen peptides which are currently much utilized in groceries or pet foods markedly lose physiological activity (ability to eliminate superoxide ions) when heated at 120° C. (unpublished data). Accordingly, when a peptide material is used in pet food prepared by high-temperature heat treatment, it is necessary to select a peptide material having excellent thermal stability.
Non-Patent Document 1: Arihara, K. 2006. Functional Properties of Bio-Active Peptides Derived from Meat Proteins. Advanced Technologies for Meat Processing (Eds. Nollet, L. M. L. and Toldra, F.) 245-273. Boca Raton, Fla., CRC Press
Non-Patent Document 2: Arihara, K. 2007. Health-Related Functions of Meat and Development of Functional Meat Products. Meat Science, 48:1-16.
Patent Document 1: JP 2004-357504 A
Patent Document 2: JP 2006-180815 A
Patent Document 3: Japan Patent No. 3651878
Patent Document 4: JP 2007-45794 A
Patent Document 5: JP 2003-102427 A

### SUMMARY OF THE INVENTION

In light of this situation, the object of the present invention is to provide a pet food material and a pet food which are effective at solving various problems related to the stresses which trouble many dogs and cats and stress-induced diseases, which do not decrease (or which increase) palatability which is an important factor in determining the value of pet food, and which have thermal stability which can resist processing by high-temperature heat treatment.

In order to solve the above-described problems, the present inventors performed diligent research and found that peptide-containing substances prepared by treatment (decomposition) of meat or fish (protein) with a protease (such as papain) have an anti-stress action in pets. They also found that these peptide-containing substances have an effect of increasing the palatability of pet food and have excellent thermal stability and therefore have suitable properties as a pet food material. As a result, they completed the present invention.

Namely, the present invention is a pet food material which is obtained by treatment of a raw material containing livestock meat protein or fish meat protein with a protease and which contains peptides consisting of 2-10 amino acid residues as a primary active ingredient, which exhibits an anti-stress action, which has an effect of increasing palatability, and which has excellent thermal stability.

The above-described peptides consisting of 2-10 amino acid residues in this pet food material are preferably peptides which can be adsorbed by a hydrophobic resin. Papain is preferable as the protease, and the livestock meat or fish meat is preferably chicken meat or bonito (katsuwonus) meat.

The above-described pet food material is suitable for use as dog food or cat food.

The present invention also relates to a pet food manufactured using the above-described pet food material. This pet food is preferably used as dog food or cat food. These pet foods are usually manufactured by high-temperature heat treatment.

The present invention additionally provides a supplement for pets which is obtained by treatment of a raw material containing livestock meat protein or fish meat protein with a protease, which contains peptides consisting of 2-10 amino acid residues as a primary active ingredient, which exhibits an anti-stress action, and which has increased palatability. The pet is preferably a dog or a cat.

The present invention further relates to a method of decreasing stress in pets characterized by administering a composition obtained by treatment of a raw material containing livestock meat protein or fish meat protein with a protease and which contains peptides consisting of 2-10 amino acid residues as a primary active ingredient.

According to the present invention, a safe pet food material can be provided which decreases the burden due to stress to which pets such as dogs and cats are subjected, which is very effective at preventing or treating diseases caused by stress, which does not impair (or which increases) palatability when it is utilized as a raw material of pet food, and which has thermal stability which can withstand high-temperature heat treatment. A pet food which is manufactured using this material can maintain an anti-stress effect and good palatability even when it undergoes high-temperature heat treatment at the time of manufacture, and it sometimes further increases palatability. Therefore, it can be eaten by pets such as dogs and cats and exhibit an anti-stress action.

### BRIEF DESCRIPTION OF THE DRAWINGS

FIG. 1—This is a figure schematically showing the process of manufacturing a peptide material manufactured using chicken meat or bonito meat as a raw material.

FIG. 2—This is a graph showing the anti-stress action (effect of preventing stress-induced stomach ulcers due to a water immersion confined stress load) when a peptide material prepared from chicken meat as a raw material was orally administered to rats.

FIG. 3—This is a graph showing the anti-stress action (effect of preventing stress-induced stomach ulcers due to a water immersion confined stress load) when a peptide material prepared from bonito meat as a raw material was orally administered to rats.

FIG. 4—This is a graph showing the anti-stress action (change in running time at the time of a forced running stress load) when a peptide material prepared from chicken meat as a raw material was orally administered to mice.

FIG. 5—This is a graph showing the antihypertensive activities when a peptide material prepared from chicken meat as a raw material was orally administered to spontaneous hypertensive rats.

FIG. 6—This is a graph showing the effect on oxidation stress in the body (using the value of serum hydroperoxide as a stress marker) when a dog food in which a peptide material prepared from chicken meat as a raw material was blended was fed to dogs.

FIG. 7—This is a graph showing the effect on serum lactic acid value (using the serum lactic acid value as a stress marker) when dog food in which a peptide material prepared from chicken meat as a raw material was blended was fed to dogs.

FIG. 8—This is a graph showing the effect on the degree of oxidation stress in the body (using the serum hydroperoxide value as a stress marker) when cat food in which a peptide material prepared from chicken meat as a raw material was blended was fed to cats.

FIGS. 9A and 9B—These are graphs showing the results of a palatability test (test comparing consumed amounts) when cat food in which was blended a peptide material prepared from chicken meat or bonito meat as a raw material was fed to cats.

FIGS. 10A and 10B—These are graphs showing the results of a palatability test (the first bite preference) when cat food in which was blended a peptide material prepared from chicken meat or bonito meat as a raw material was fed to cats.

### DESCRIPTION OF PREFERRED EMBODIMENTS

A pet food material according to the present invention is obtained by treatment of a raw material containing livestock meat or fish meat with a protease. This material has excellent thermal stability and has peptides consisting of 2-10 amino acid residues as a primary active ingredient.

The above-described livestock meat or fish meat has animal muscle as a primary component. Therefore, a material containing muscle or muscle protein can be used as a raw material for preparation. From the standpoint of ease of acquisition and the like, chicken, pork, beef, bonito (katsuwonus), tuna, horse mackerel, sardines, salmon, and the like are suitable as livestock meat or fish meat. Among these, chicken meat and bonito meat, from which it is easy to prepare products having stable quality, are preferred, but the present invention is not limited to these types of livestock or fish. Livestock meat according to the present invention includes meat from poultry such as chickens, quails, ducks, and the like, and fish meat includes shellfish containing muscles and broadly means seafood. There is no particular limitation on the location or condition of muscle, and any method of preparing the livestock meat or fish meat can be used if it can obtain a material including a sufficient amount of muscle protein.

Protease used for decomposition of livestock meat or fish meat is not limited to any particular one, and any type can be used as long as it can suitably decompose muscle protein. Protease treatment of livestock meat or fish meat can be carried out by adding protease to a raw material containing livestock meat or fish meat, such as livestock meat or fish meat which has been crushed or ground, or it can be added to an aqueous suspension formed by adding water and then crushing or grinding. Preferred examples of proteases are papain, bromelain, ficin, α-chymotrypsin, thermolysine, proteinase K, pronase E, and the like. Among these, it is particularly preferable to use papain as an enzyme which can provide a degradation product having both a high anti-stress action and the effect of improving palatability.

When activating protease, if the temperature, pH, and the like are set to optimum conditions for protease, a degradation product can be quickly obtained, but it is also possible to perform control by means of the added amount of protease and the reaction time, so it is not necessary to limit conditions to specific ones. After livestock meat or fish meat is decomposed by protease, the solution is preferably heated to around 85-100° C. to deactivate protease.

After protease is deactivated, the suspension may be used as is after a suitable preservation method such as cooling or freezing, or it may be dried by a suitable method such as freeze drying, spray drying, or drum drying and formed into a powder. A material which is dried and powderized is suitable for long periods of storage and is in a form which makes it easy to handle in transport and processing.

A composition which is obtained by treatment of livestock meat or fish meat with a protease in the above-described manner (a peptide material) contains peptides consisting of 2-10 amino acid residues and preferably 2-5 amino acid residues as a main component. These peptides preferably are peptides which have comparatively strong hydrophobic properties and which can be adsorbed by a hydrophobic resin such as octadecylsilyl silica gel.

A pet food prepared from this peptide material was confirmed by Example 5 to have an anti-stress action on dogs and cats. Specifically, in an environment which induces stress in animals, a stress index in vivo was measured to confirm the anti-stress action of a pet food material according to the present invention. In addition, Example 7 shows the effect of increasing palatability of a pet food material of the present invention. Accordingly, it is clear that the anti-stress action and the palatability of this material are not degraded by high-temperature heat treatment.

A composition which is prepared by treatment of livestock meat or fish meat with a protease and which has peptides consisting of 2-10 amino acid residues as a main component can be added to pet food (dog food or cat food) as a pet food material and given to pets such as dogs or cats. The added amount necessary to exhibit an anti-stress action and an effect of increasing palatability is around 0.1-10 weight % in the case of a usual pet food. However, in the case of special pet foods, supplements, or medicines which are taken in small amounts each time, 10 weight % or more may be added. When a material according to the present invention is added to a pet food, additives (nutritional additives such as vitamins and minerals, taste/odor/appearance improving agents such as sweeteners, flavors, and pigments) may be used as long as they do not impair the effects of the present invention.

A peptide pet food material according to the present invention has excellent thermal stability. Therefore, there are no problems at all with respect to physiological activity or palatability when it is added to a suitable pet food and the like and processed (mixed, heated, and the like). There are no particular restrictions on a method of manufacturing a pet food using this material, and it can be blended in a pet food raw material (added or mixed), or it can be coated on the surface of manufactured pet food. Heat treatment carried out when manufacturing pet food is normally performed at a high temperature. In the case of dry food, for example, the heating temperature in an extruder is often around 110-135° C., and subsequent drying is often carried out at around 140° C. However, there is no marked decrease in the physiological action of a peptide material according to the present invention from such treatment. From the standpoint of an increase in palatability, carrying out heat treatment at around 120° C. forms an aroma which is liked by dogs and cats by the Maillard reaction. Therefore, when a greater effect of increasing palatability is desired in a material according to the present invention, it is recommended that conditions be set so as to promote the Maillard reaction by lengthening the heating time or the like after mixing the material with other raw materials.

There is no particular limitation on the type of pet food which utilizes a pet food material according to the present invention. Some examples are dry type or wet type dog food or cat food which is most common at present as commercial pet food, all types of drinks for pets, kneaded products for pets such as sausage or paste, and snacks for pets. A pet food or a pet food material according to the present invention is particularly suitable for use with dogs and cats in light of the frequency of occurrence and severity of problems due to various types of stress, but it can be fed to pets other than dogs and cats or to livestock or poultry.

A composition which is prepared by treatment of livestock meat or fish meat with a protease and which has peptides consisting of 2-10 amino acid residues as a main component is suitable for use as a supplement for decreasing stress of pets such as dogs or cats. In the case of a supplement as well, if the supplement has low palatability, it is not sufficiently eaten by animals and cannot exhibit its effects. Therefore, it is important to increase its palatability. It is also anticipated that this composition can be used as a medicine for decreasing stress in pets.

Stress in the present invention is not limited to any particular type. Some specific examples are insufficient exercise, being raised indoors, insufficient contact with the owner, excessive discipline, noise, air pollution, bad smells, medical treatment, and other environmental factors which are unpleasant to pets. Stress caused by such environmental factors produces oxidation stress accompanying the formation of active oxygen (or free radicals) within the body. Oxidation stress produces nervous disorders and abnormal behavior by producing disturbance of the biological defense system such as damage to cell membranes and the like. It is also the cause of many diseases (such as cardiovascular diseases, digestive organ diseases, kidney diseases, skin diseases, cranial nerve diseases, diabetes, respiratory diseases, blood diseases, and eye diseases). Accordingly, stress according to the present invention can be said to be “anything which brings about a disturbance of the biological system by oxidation stress (formation of free radicals)”.

Below, the present invention will be explained by examples. The following examples are for the purpose of explaining the present invention and do not limit it.

### Example 1

### Method of Preparing a Peptide Material Using Livestock Meat or Fish Meat as a Raw Material

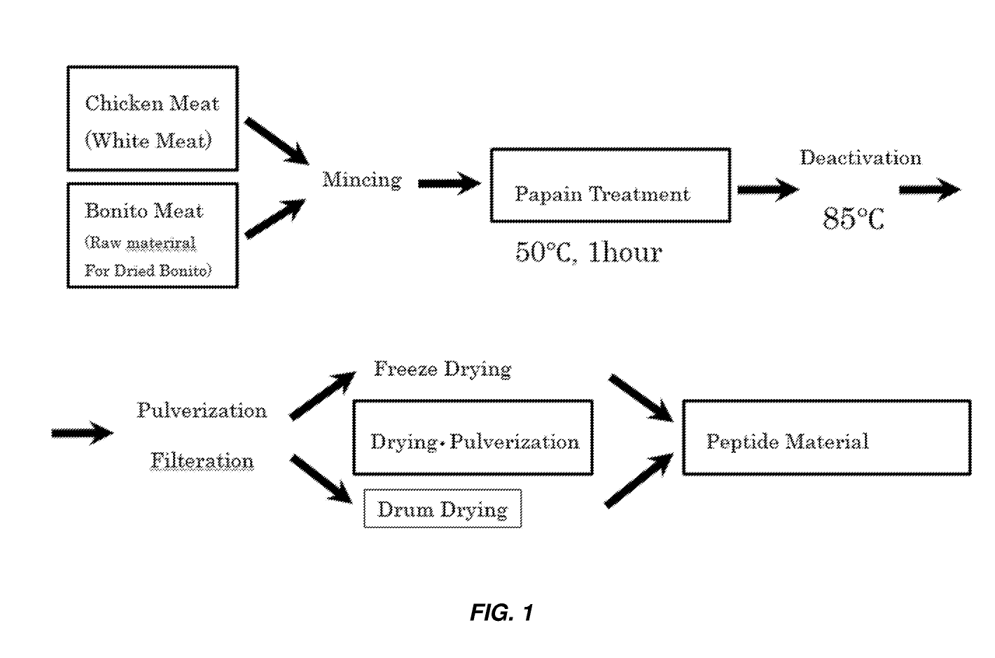

The steps when preparing a peptide material according to the present invention using livestock meat or fish meat as a raw material are schematically shown in FIG. 1. In this example, chicken meat was used as livestock meat, and bonito meat was used as fish meat. After the removal of fat and connective tissue as much as possible, chicken meat (white meat of broilers) was thinly sliced and water was added to it so that it could be easily minced. Mincing was performed to obtain a nearly uniform meat suspension to which papain (purified papain FL-3 from Asahi Food and Health Care Corporation) was added to the suspension as a protease (0.25-1.50 weight %). After an enzyme reaction was carried out for one hour at 50° C., heating was carried out for one hour at 85° C. to deactivate the papain. The coagulated lumps which were formed by heating at this time were pulverized and formed into a somewhat uniform suspension, which was then filtered with a metal mesh to remove large particles. The filtrate which was obtained was freeze dried and then pulverized, and the resulting powder was used as a peptide material. This drying process can be performed without problems by a heat drying method such as air drying or drum drying. Particularly when a large quantity is being prepared, a heat drying method is superior to freeze drying from the standpoint of cost. When bonito meat was used as a raw material, the portions mainly comprising skeletal muscle obtained after removing the head and internal organs which can be used as a raw material for dried bonito (frozen stored products of the portions used in the manufacture of dried bonito before boiling) were used. After thawing, the same treatment was carried out as for chicken meat.

Table 1 shows the results of investigation of the relationship between the added amount of papain used as a protease and the peptide content (amount formed) when preparing a peptide material using chicken meat and bonito meat as a raw material by the above-described process. In the case of chicken meat, when the added amount of papain was around 0.50-1.00 weight %, the peptide content was high. In the case of bonito meat, when the added amount of papain was 1.00-1.25 weight %, the peptide content was high. Based on these results, the added amount of papain was made 0.50 weight % in the case of a chicken meat raw material and was made 1.00 weight % in the case of a bonito meat raw material in the process of preparing a peptide material used in the following investigation (example). Heating for one hour at 85° C. (papain deactivation conditions) had almost no effect on the activity of this material (anti-oxidation activity, i.e. ability to eliminate superoxide ions, a measurement method are set forth in below-described Example 6).

TABLE 1
Peptide content (%)
Added amount of papain (%)

| | Before | | | | | | |
|---|---|---|---|---|---|---|---|
| | decomposition | 0.25 | 0.50 | 0.75 | 1.00 | 1.25 | 1.50 |
| Chicken | 3.6 | 29.2 | 51.2 | 54.4 | 53.8 | 49.6 | 44.6 |
| meat | | | | | | | |
| Bonito | 5.8 | 15.2 | 23.2 | 28.8 | 36.0 | 38.2 | 31.4 |
| meat | | | | | | | |

### Example 2

### Effect of Preventing Stress-Induced Stomach Ulcers in Rats by Oral Administration of a Peptide Material

First, in order to verify the anti-stress action of a peptide material in laboratory animals, a test of the occurrence of stress-induced stomach ulcers was carried out using rats. Seven-week old male SD rats (Clea Japan, Inc.) were used as experimental animals. Rats in a test group were orally administered a peptide material (prepared by the same method as set forth in Example 1 from a chicken meat or bonito meat raw material), while rats in a control group were orally administered water or an undecomposed material (a meat material prepared without addition of papain). A test of the occurrence of stress-induced stomach ulcers was carried out as follows: Forced oral administration of one ml of the sample per 100 grams of body weight (5 mg as the material) was conducted once a day for seven days using a stainless steel stomach feeding tube, and after final administration, fasting was carried out for 24 hours. After fasting, the rats were placed in a water immersion constrained stress test cage and immersed in water at 20° C. so that the rats were out of the water from the neck up. After a water immersion constrained stress load was applied under these conditions for 24 hours, the stomach was excised from each rat, washed, and then fixed in formalin. The application of a water immersion constrained stress causes stress-induced stomach ulcers to form in the stomachs of rats, but stomach ulcers are not observed in the stomachs of healthy rats which have not been subjected to a water immersion constrained stress. The formation of stress-induced stomach ulcers is suppressed by oral administration of a material having an anti-stress action.

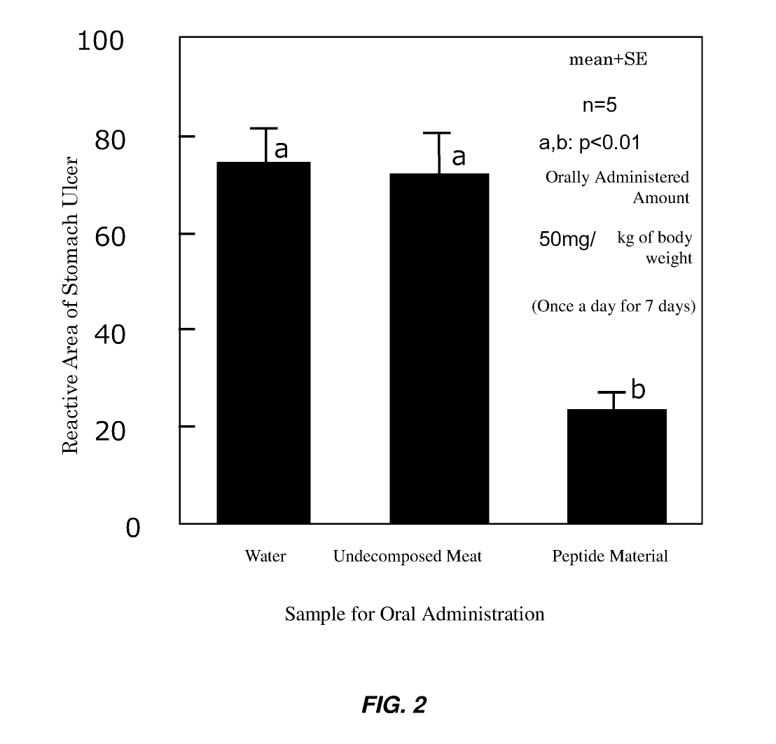

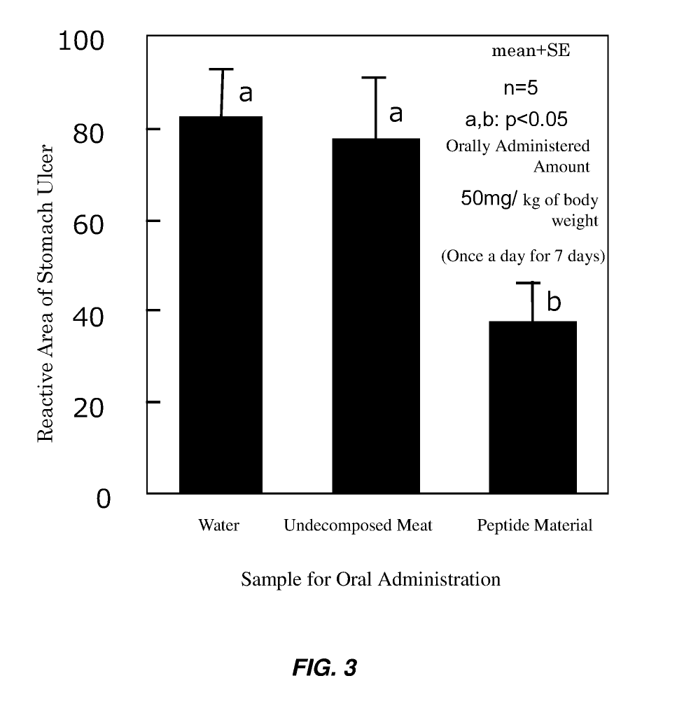

The results of measurement of the total surface area of ulcers produced in the stomach wall which was fixed in formalin in this test (the relative proportion of area) are shown in FIG. 2 (for a peptide material prepared using chicken meat as a raw material) and FIG. 3 (for a peptide material prepared using bonito meat as a raw material). It was ascertained that the formation of stress-induced stomach ulcers was markedly suppressed by oral administration to rats of a peptide material prepared using chicken meat or bonito meat as a raw material. From this fact, it can be seen that a peptide material proposed by the present invention has an anti-stress action at least in omnivorous animals such as rats.

### Example 3

### Effect Exhibited in a Forced Running Stress Load in Mice Orally Administered a Peptide Material

The effect of oral administration of a peptide material prepared using chicken meat as a raw material during the application of a forced running stress load was investigated. The effect was determined by the change (elongation) in the running time when mice which were orally administered a peptide material were forced to run. The mice were 5 to 6-week old ICR males (Charles River Laboratories Japan Inc.). Forced running by the mice was carried out using a MK-680S treadmill (Muromachi Kikai Co., Ltd.) with the running surface sloped at 15° and a belt speed of 20 meters per minute. Prior to oral administration of a sample such as a peptide material, mice were forced to run for 4 hours on a treadmill, and after a certain degree of fatigue was reached, they were orally administered a test solution using a stainless steel stomach feeding tube. The amount of the orally administered test material was 0.2 ml per mouse (5 mg of material per 100 g of body weight). A peptide material prepared using chicken meat as a raw material (prepared by the method described in Example 1) was orally administered to mice in a test group, and mice in a control group were orally administered saline or an undecomposed material (a chicken meat material prepared without addition of papain). Fifteen minutes after oral administration, forced running was started, and the length of time for which the mice ran was measured. The end of running was considered to take place when a mouse reached the limit of fatigue by forced running and stopped running, and contact with an electrode at the rear of the running surface of the treadmill continued for at least 5 seconds. The electrode voltage was set to 100 volts so that running would continue until a mouse reached the limit of its fatigue. Mice dislike contact with electrodes (electric shocks), so they continue to run until their fatigue reaches a limit.

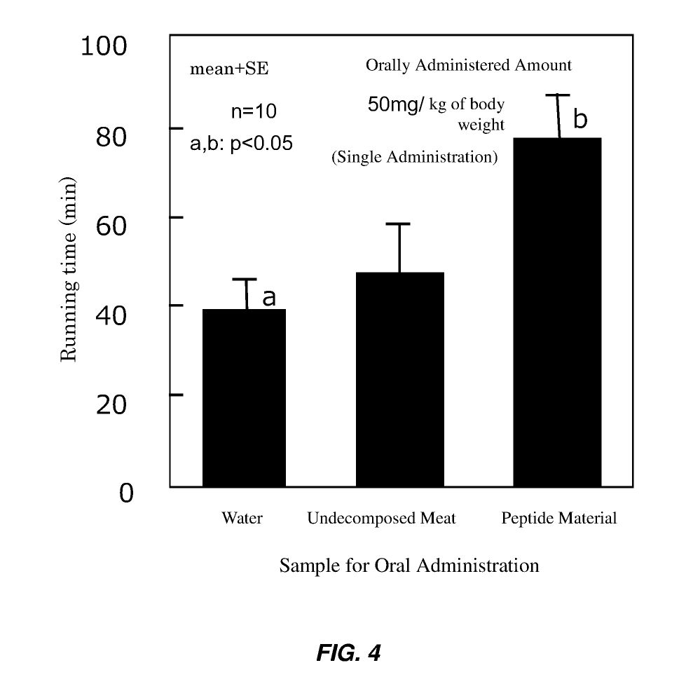

As shown in FIG. 4, oral administration of a peptide material prepared from chicken meat as a raw material markedly prolonged the running time of mice. Mice which were orally administered a peptide material ran for approximately 2 times as long as the control group which was administered water. An undecomposed material did not have any effect, so the above effect is thought to be due to peptides in the peptide material. From this experiment, it was determined that a peptide material according to the present invention has an effect of decreasing the occurrence of fatigue due to a forced running stress load at least in omnivorous animals such as mice.

### Example 4

### Effect of Regulating Blood Pressure in Rats Orally Administered a Peptide Material

It is known that the blood pressure of animals increases due to a stress lord, and the incidence of high blood pressure is closely related to stress. Therefore, it was investigated whether oral administration of a peptide material according to the present invention has an effect of regulating blood pressure using spontaneous hypertensive rats.

A peptide material prepared using chicken meat as a raw material (prepared by the method described in Example 1) was orally administered using a stainless steel stomach feeding tube to spontaneous hypertensive rats (Charles River Laboratories Japan Inc., 10 rats per group, 15 to 20-week old males). The amount of the test material which was administered (a peptide material and an undecomposed material) was made 5 mg per 100 g of body weight of the rats, and the administered amount was made 1 ml per rat. The same amount (1 ml) of water was orally administered to a control group. The value of the blood pressure (systolic pressure) in the tail artery after oral administration with a stomach feeding tube was measured, the highest blood pressure just before administration was subtracted, and the difference was made the variation in blood pressure. Measurement of blood pressure was carried out by the tail cuff method using a BP-98A bloodless type blood pressure manometer (Softron Corporation).

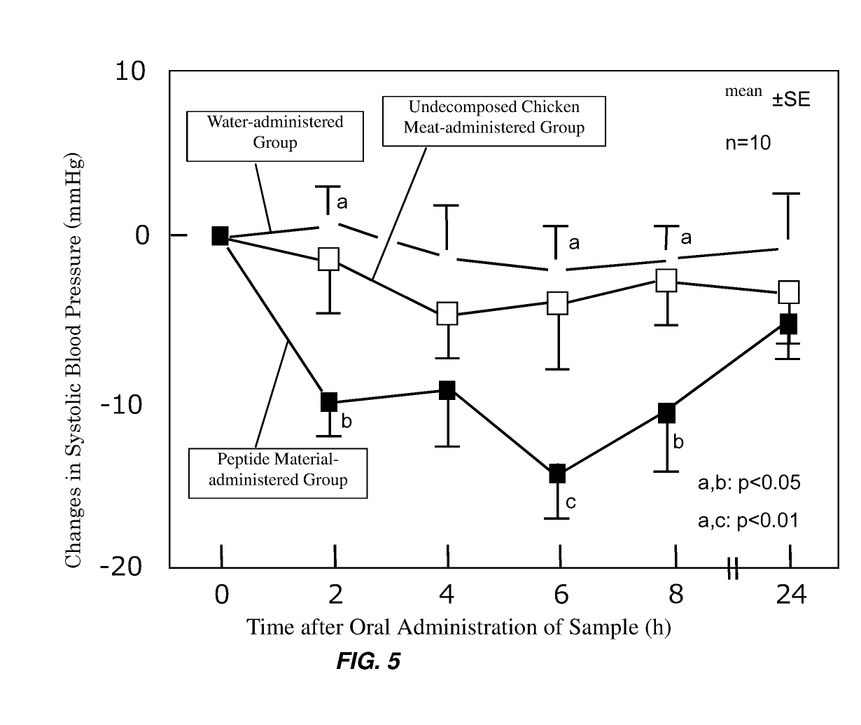

The results of viewing the variation in blood pressure (systolic pressure) with time after oral administration of a peptide material prepared from chicken meat as a raw material to spontaneous hypertensive rats are shown in FIG. 5. In the group which was administered a peptide material, a decrease in blood pressure was observed after 2-8 hours. This change in blood pressure was not observed in the group administered water or the group administered undecomposed material. Therefore, it was determined that peptides contained in a peptide material had an effect of adjusting (lowering) blood pressure at least in omnivorous animals such as rats. The same effect of lowering blood pressure was observed with a peptide material prepared from bonito meat as a raw material.

### Example 5

Anti-Stress Effect on Dogs and Cats Fed Pet Food in which a Peptide Material is Blended

A peptide material prepared from chicken meat as a raw material or a chicken meat material which was not decomposed (each prepared by the method set forth in Example 1) was blended in a basic raw material for pet food in an amount of 10%. The composition of a basic raw material for dog food was 60.80% of grains (corn and wheat flour), 4.50% of brans (gluten feed, wheat bran, and beet pulp), 5.00% of seafood (fish meal), 10.00% of meat (chicken meal), 5.50% of beans (degreased soybeans), 5.50% of vegetable protein (gluten meal), 0.30% of vitamins, 1.40% of minerals, 1.50% of extracts, and 5.50% of oils and fats (beef tallow). The composition of a basic raw material for cat food was 52.85% of grains (corn, wheat flour, rice flour), 12.40% of seafood (fish meal), 10.00% of meat (chicken meal), 14.00% of vegetable protein (gluten meal), 0.50% of vitamins, 1.90% of minerals, 2.50% of extracts, 5.00% of fats and oils (beef tallow), and 0.85% of other components (beer yeast, oligosaccharides, taurine, and methionine). After the materials (the peptide material prepared from chicken meat as a raw material or undecomposed chicken meet material) were blended with the basic raw materials, they were pulverized and mixed, water was added, and the mixture was subjected to extrusion molding with an extruder (a heat and pressure extruder) at 110° C. for 30 seconds, it was dried (at 140° C. for 15 minutes), and it was formed into pellets (dry type pet food).

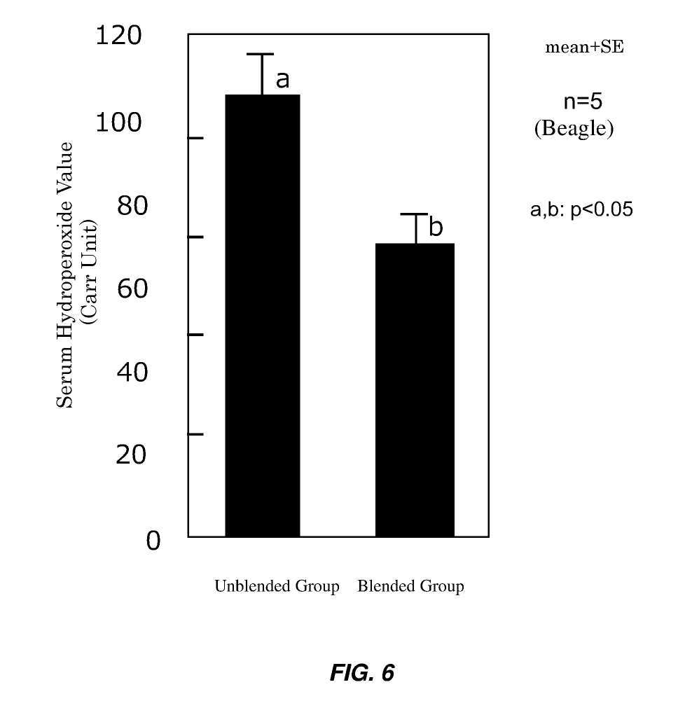

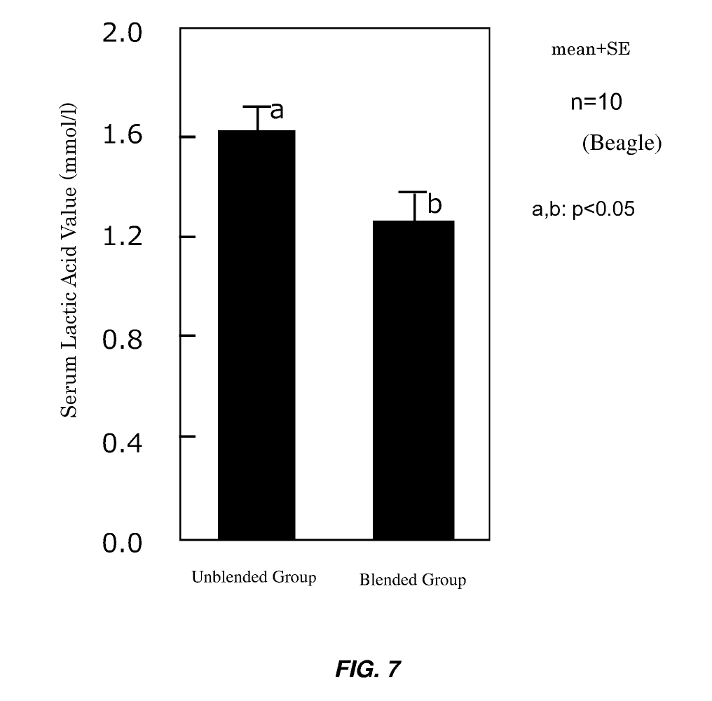

Dog food in which was blended a peptide material (blended group) or dog food in which was blended undecomposed chicken meat material (unblended group) was fed for 5 days to beagles raised in cages (a stress-inducing environment) (280 g per animal per day). At the end of the feeding period, blood was drawn, and the blood serum hydroperoxide value and the blood serum lactic acid value were measured as stress indices in the body. A FREE free radial evaluation system (Wismerll Co., Ltd.) was used for measurement of hydroperoxide value and a Lactate Pro LT-1710 blood lactic acid meter (Arkray, Inc.) was used for measurement of the lactic acid value. The results are shown in FIG. 6 and FIG. 7. The dogs which ate dog food in which was blended a peptide material prepared from chicken meat as a raw material all had a decrease in stress indices. From this fact, it was ascertained that a material according to the present invention exhibits an anti-stress action with respect to dogs which are descended from carnivores having nutrient physiological characteristics which are different from those of rats (Examples 2 and 4) or mice (Example 3). In addition, since this is a result obtained using dog food prepared by high-temperature heat treatment at the time of extrusion molding and drying (110° C. for 30 seconds and 140° C. for 15 minutes), it is clear that a peptide material according to the present invention provides excellent thermal stability when blended as a dog food material.

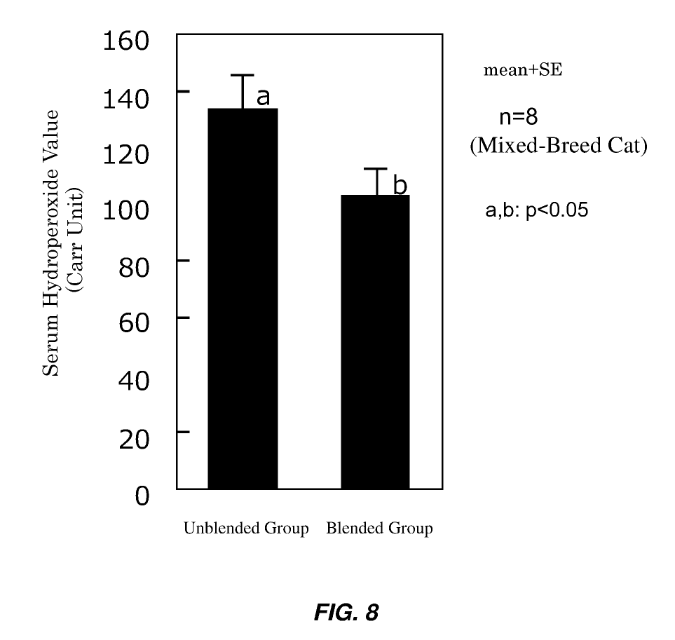

Similarly, cat food in which was blended a peptide material (blended group) or cat food in which was blended an undecomposed chicken meat material (unblended group) was fed for 5 days to mixed-breed cats raised in cages (a stress-inducing environment) (80 g per day per animal). At the completion of the feeding period, blood was drawn, and the blood serum hydroperoxide value was measured. The results are shown in FIG. 8. The cats which ate cat food in which was blended a peptide material prepared from chicken meat as a raw material had a decrease in the stress index. From this fact, it was ascertained that a material according to the present invention has an anti-stress action with respect to cats, which exhibit clear carnivorous tendencies. In the same manner as with dog food, these results were obtained using cat food which was prepared by high-temperature heat treatment at the time of extrusion molding and drying (110° C. for 30 seconds plus 140° C. for 15 minutes). Therefore, it is clear that a peptide material according to the present invention has excellent thermal stability when it is blended as a cat food material.

### Example 6

### Properties of Active Ingredients Contained in a Peptide Material

It is thought that there are many peptides contained in a peptide material according to the present invention which exhibit an anti-stress action. Important among these are anti-oxidizing peptides and blood pressure-adjusting peptides. Anti-oxidation activity (superoxide ion extinguishing ability) and blood pressure-lowering action (angiotensin I converting enzyme inhibiting activity, referred to below as ACE inhibiting activity) were employed as in vitro indices of anti-stress action and investigated.

Measurement of anti-oxidation activity was carried out using a method in which superoxide ions were measured by chemiluminescence. Hypoxanthine was reacted with xanthine oxidase in the presence of a measurement sample such as a peptide to form superoxide ions, which were reacted with a luminescence reagent, 2-methyl-6-p-methoxyphenyl ethynyl imidazopyranozine (MPEC, Atto Corporation), and the amount of luminescence was measured with an AB-2200 luminescence sensor (Atto Corporation). The anti-oxidation activity was calculated by the following formula: anti-oxidation activity (%)=(measured value of control−measured value of sample)/measured value of control×100.

Measurement of ACE inhibition activity was carried out by colorimetry of liberated hippuric acid, utilizing the selective cutting of the terminus of the substrate by ACE using hippuric acid-L-histidyl-L-leucine (Sigma Corporation) which is a synthetic substrate. ACE inhibiting activity was calculated using the following equation. ACE inhibiting activity (%)=absorbance of control−absorbance of sample)/(absorbance of control−absorbance before reaction)×100.

Fractionation (batch method) of the peptide material was carried out using a hydrophobic resin (Wakosil 40C18, Wako Pure Chemical Industries, Ltd.). Namely, the peptide material was dissolved in distilled water, and the insoluble portion was removed by centrifugal separation. Then, the solution was violently mixed with the hydrophobic resin and divided into a fraction which was adsorbed by the hydrophobic resin and a fraction which was not adsorbed. When the superoxide extinguishing ability and the ACE inhibiting activity of both fractions were measured, most of the activity was found in the fraction which was adsorbed by the resin and which contained the peptide having relatively strong hydrophobicity. When this fraction was freeze dried and orally administered to 5 to 6-week old male ICR mice (Charles River Laboratories Japan Inc.) using a stainless steel stomach feeding tube, it was found that the value of blood serum hydroperoxide (a stress marker) had decreased, and this confirmed that peptides exhibiting an anti-stress action were recovered in the fraction containing peptides having relatively strong hydrophobicity.

The peptide fraction which was roughly purified by the above-described hydrophobic resin was further subjected to fractionation by gel filtration chromatography (Poly HYDROXYETHYL A 200×9.4 mm column, PolyLC Inc.) and the ethanol sedimentation method, and most of the anti-oxidation activity and the ACE inhibiting activity were found in the fraction containing peptides consisting of 2-10 amino acid residues as a main component. When this fraction was orally administered to mice, the serum hydroperoxide level decreased.

From the fraction containing peptides which were roughly purified using the above-described hydrophobic resin, active peptides were purified by reversed phase high speed liquid chromatography (HPLC). The apparatus was a LC-VP system manufactured by Shimadzu Corporation, and XBridge C18 (4.6×150 mm, Waters Corporation), and Atlantis C18 (4.6×150 mm Waters Corporation) were utilized in the reversed phase column. As a result of purifying by reversed phase HPLC, the presence of various anti-oxidizing peptides and ACE inhibiting peptides was suggested, and peptides consisting of 2-5 amino acid residues such as those shown in Table 2 were identified. Identification of peptides was carried out using a PPSQ-31A protein sequencer (Shimadzu Corporation) and a QP8000a mass spectrometer (Shimadzu Corporation). It was suggested that many kinds of anti-oxidizing peptides and ACE inhibiting peptides as well as other physiologically active peptides were present in the peptide material. The anti-stress action of the peptide material is not manifested only by the substances shown in Table 2.

TABLE 2

| Raw | Physiological | |
|---|---|---|
| material | activity | Amino acid sequence |
| Chicken | antioxidation | Val-Glu-Pro-Ser |
| meat | antioxidation | Val-Trp |
| | ACE inhibition | Ile-Arg-Val-Val-Glu |
| | ACE inhibition | Val-Gly-Arg |
| Bonito | antioxidation | Asp-Leu-Tyr-Ala |
| meat | antioxidation | Glu-Pro-Ala-Val-Lys |
| | ACE inhibition | Ile-Trp-His |

### Example 7

### Effect of Increasing Palatability of Pet Food by Blending a Peptide Material

Palatability is extremely important as a factor for evaluating the quality of pet food. If pets refuse to eat pet food, the marketability of the pet food becomes extremely poor even if the pet food has excellent health effects. In addition, the owner feels extremely satisfied to see pets happily eating pet food, and this satisfaction is linked with purchasing activity. Of cats and dogs which are typical pets, it is known that cats are especially particular about palatability. Therefore, cats were used to investigate the palatability of pet food having a peptide material blended therein.

A peptide material prepared using chicken meat or bonito meat as a raw material or an undecomposed chicken meat or bonito meat material (each prepared by the method described in Example 1) was blended in a cat food basic raw material (described in Example 5) in an amount of 10%. After the material was blended in the basic raw material, pulverization and mixing were performed, water was added, and then extrusion molding (110° C. for 30 seconds) was carried out using an extruder (heated pressurized extruder), and drying was performed (140° C. for 15 minutes) to prepare pellets (dry type cat food).

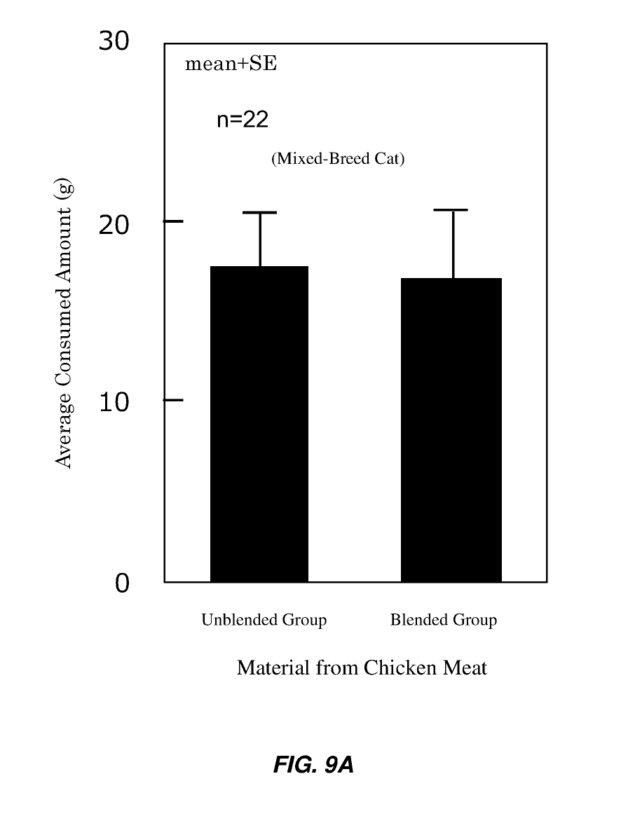

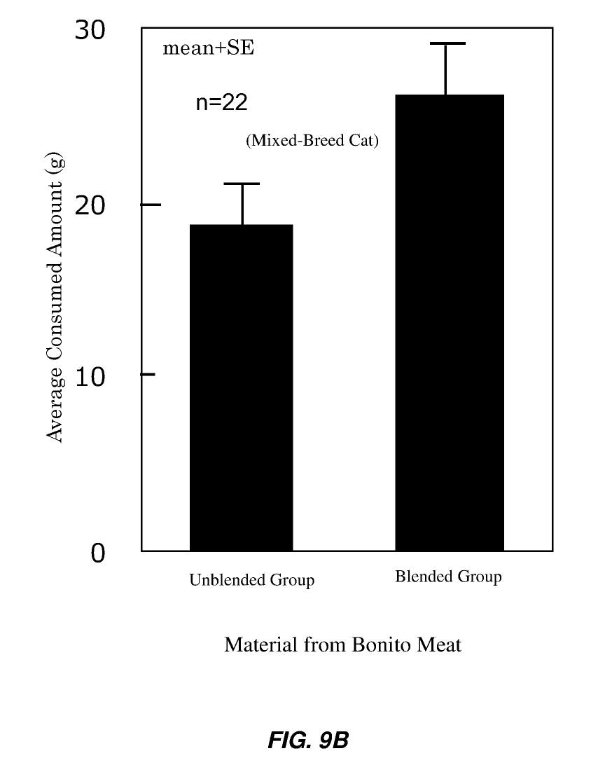

A palatability test was carried out by a two-point comparison method (a test comparing consumed amounts). Namely, 100 g of each of two types of test foods were placed into separate feeding vessels and installed in a cage, and then feeding of cats began. The amount that was eaten was determined by measuring the weight of food after 24 hours (the uneaten amount). The results are shown in FIG. 9. Blending of the peptide material prepared from chicken meat or bonito meat as a raw material did not decrease the palatability of cat food.

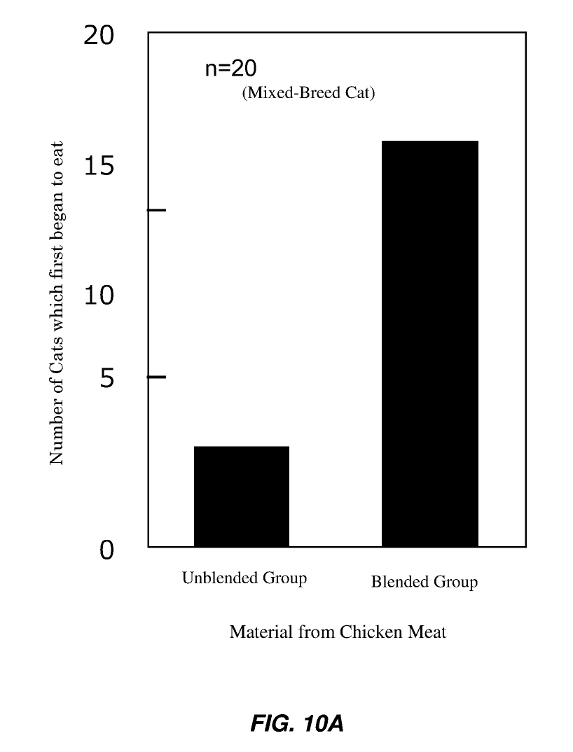

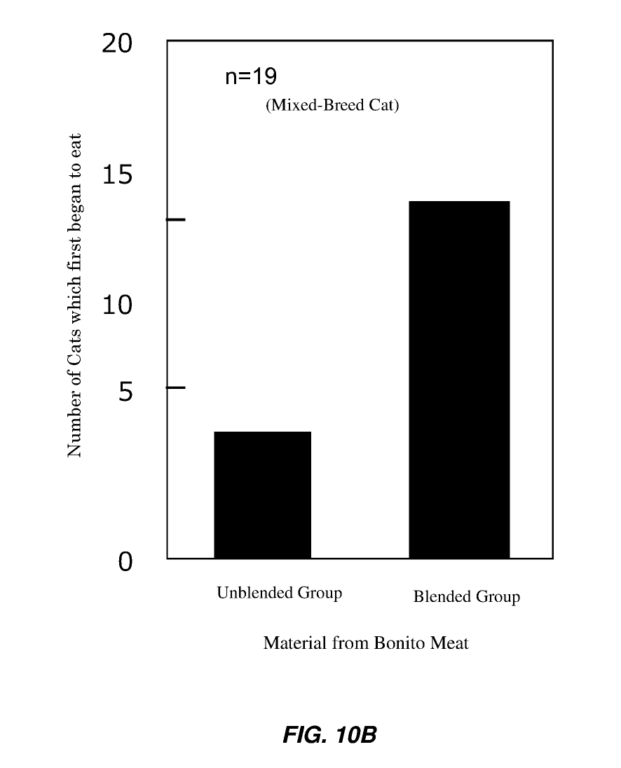

That pet food is preferentially eaten when given to a pet is important in pleasing an owner. In the same manner as in the above-described consumed amount comparison test, when two types of test foods were placed side by side and feeding of cats began, it was observed which of the foods first began to be eaten (the first bite preference). The results are shown in FIG. 10. Cat foods having peptide material blended therein were eaten in preference to the control food (food blending undecomposed material) for both the peptide material from the chicken meat raw material and that from the bonito meat raw material, i.e. most cats first began to eat food having the peptide material blended therein. This result shows that a pet food material according to the present invention becomes a pet food material having excellent palatability. This result was obtained using cat food prepared by high-temperature heat treatment during extrusion molding and drying (110° C. for 30 seconds+140° C. for 15 minutes). Therefore, when a peptide material according to the present invention is blended in cat food, it is clear that it has excellent thermal stability and the effect of increasing palatability is not impaired by heat treatment.

When an owner buys a new pet food and switches from a pet food which was previously being used, the pet sometimes does not immediately accept the new food. Therefore, the change in the consumed amount when food was switched was observed to investigate whether food having a peptide material blended therein was accepted without problems when food was switched.

Cat food in which a peptide material prepared from chicken meat as a raw material was blended was the same as that used in the above-described palatability test. The food for 10 cats which had been continuously fed cat food comprising only the basic raw material described in Example 5 was replaced by food in which 10% of a peptide material was blended, and the change in the uneaten amount was observed. The amount administered was 80 g per day per cat. The results of measurement of the amount of food left over for 4 days before and after switching took place are shown in Table 3. The average amount left over (amount per day) for the 4 days before switching was 12.6 g, whereas the average for the 4 days after switching to food in which a peptide material was blended was 3.0 g. Namely, the amount left over decreased after switching of food, and it was determined that cats accepted the new food after switching without problems.

TABLE 3
Weight of uneaten cat food (g)

| Before switching | | | | | | | |
|---|---|---|---|---|---|---|---|
| Day | | | | After switching | | | |
| −4 | Day −3 | Day −2 | Day −1 | Day +1 | Day +2 | Day +3 | Day +4 |
| 17.6 | 9.2 | 16.2 | 7.2 | 7.6 | 2.6 | 1.6 | 0.3 |

The value for the day on which the food was switched (Day 0) is not shown.

A similar test of observing the effect of switching food was carried out with dogs, but almost all of the dogs completely ate the administered food (280 g per day per dog) both before and after switching the dog food, so no difference in the uneaten amount could be observed. However, this fact confirmed that blending a peptide material according to the present invention in dog food does not worsen its palatability.

The invention claimed is:

1. A method of preparing cat food having anti-stress action and increased palatability, comprising the steps of:
performing, using an extruder, extrusion molding of a raw material at 110° C. for 30 seconds to provide an extruded product, wherein the raw material comprises a peptide material consisting of 2-10 amino acid residues and the peptide materials is obtained from treatment of livestock meat of fish meat with a protease; and
drying the extruded product at 140° C. for 15 minutes,
wherein the peptide material comprises by weight about 10% of the mixture and at least one peptide having a sequence Val-Glu-Pro-Ser, Ile-Arg-Val-Val-Glu, Val-Gly-Arg, or Glu-Pro-Ala-Val-Lys.

2. The method according to claim 1, wherein the livestock meat or fish meat is chicken meat or bonito meat.

3. The method according to claim 1, wherein the livestock meat or fish meat is bonito meat.

4. The method according to claim 1, wherein the livestock meat or fish meat is treated with a protease in an amount of 0.25-1.50 wt % for one hour at 50° C.

5. A method of increasing palatability of cat food, comprising the steps of:
performing, using an extruder, extrusion molding of a raw material at 110° C. for 30 seconds to provide an extruded product, wherein the raw material comprises a peptide material consisting of 2-10 amino acid residues and the peptide materials is obtained from treatment of livestock meat of fish meat with a protease; and
drying the extruded product at 140° C. for 15 minutes,
wherein the peptide material comprises by weight about 10% of the mixture and at least one peptide having a sequence Val-Glu-Pro-Ser, Ile-Arg-Val-Val-Glu, Val-Gly-Arg, or Glu-Pro-Ala-Val-Lys.

6. Cat food produced by the method according to claim 5.
